(19) United States
(12) Patent Application Publication
(10) Pub. No.: US 2020/0154555 A1
(43) Pub. Date: May 14, 2020

(54) FLOW FIELD VISUALIZATION DEVICE, FLOW FIELD OBSERVATION METHOD, AND PLASMA GENERATOR

(71) Applicant: Industrial Technology Research Institute, Hsinchu (TW)

(72) Inventors: Chih-Yung Huang, Taichung City (TW); Kuan-Chou Chen, Hsinchu City (TW); Shih-Chin Lin, New Taipei City (TW); Yi-Jiun Lin, Chiayi County (TW); Ching-Chiun Wang, Miaoli County (TW)

(73) Assignee: Industrial Technology Research Institute, Hsinchu (TW)

(21) Appl. No.: 16/223,044

(22) Filed: Dec. 17, 2018

(30) Foreign Application Priority Data
Nov. 9, 2018 (TW) 107139911

(51) Int. Cl. H05H 1/00; H05H 1/24; H04N 5/247; G06T 7/246

(52) U.S. Cl. CPC H05H 1/0025; H05H 1/24; H05H 2001/469; G06T 7/248; H04N 5/247

(57) ABSTRACT

A flow field visualization device includes a chamber, a power supply, at least one pair of electrodes, and at least two high-speed cameras. The power supply outputs a voltage for plasma generation, and the pair of electrodes is disposed in the chamber. The pair of electrodes includes a first electrode and a second electrode. The first electrode has a plurality of first tips, the second electrode has a plurality of second tips, and the first tips and the second tips are aligned with each other. The pair of electrodes generates a periodically densely distributed plasma by exciting a gas in the chamber through the voltage from the power supply. The high-speed cameras are disposed outside the chamber and are positioned in different directions corresponding to the pair of electrodes in order to capture images of different dimensions.

### CROSS-REFERENCE TO RELATED APPLICATION

This application claims the priority benefit of Taiwan application serial no. 107139911, filed on Nov. 9, 2018. The entirety of the above-mentioned patent application is hereby incorporated by reference herein and made a part of this specification.

### TECHNICAL FIELD

The disclosure relates to a flow field visualization device, a flow field observation method, and a plasma generator.

### BACKGROUND

Since conventional visualization analysis requires laser for illumination to allow high-speed cameras to acquire images, it is confined by the shape of the chamber and air extraction, which have an impact on particle turbulence. Moreover, the pressure is required to be within the normal pressure range, so that an image of the particles can be effectively captured. Therefore, the flow field of the low-pressure vacuum CVD process cannot be measured.

In addition, in the conventional visualization analysis method using a laser light source, it is required to additionally adopt a prism set composed of a concave lens and a convex lens to refract the laser beam into a flat beam plane, and it is required to adjust the flow field to the position having the least thickness in the laser beam plane, so a result of a two-dimensional space is obtained.

### SUMMARY

The disclosure provides a flow field visualization device capable of improving the image-capturing range of flow field visualization and achieving three-dimensional flow field observation.

The disclosure also provides a flow field observation method for performing flow field observation through a non-uniform imaging plasma development technique.

The disclosure further provides a plasma generator capable of generating a periodically densely distributed plasma.

The flow field visualization device of the disclosure includes a chamber, a power supply, at least one pair of electrodes, and at least two high-speed cameras. The power supply outputs a voltage for plasma generation. The pair of electrodes is disposed in the chamber. The pair of electrodes includes a first electrode and a second electrode. The first electrode has a plurality of first tips, the second electrode has a plurality of second tips, the first tips and the second tips are aligned with each other. The pair of electrodes generates a periodically densely distributed plasma by exciting a gas in the chamber through the voltage from the power supply. The high-speed cameras are disposed outside the chamber and are positioned in different directions corresponding to the pair of electrodes.

The flow field observation method of the disclosure includes the following steps. A periodically densely distributed plasma is generated by using a plasma generator disposed in a chamber, and then a gas image excited by the plasma is captured by using at least two high-speed cameras. The plasma generator includes at least one pair of electrodes. The pair of electrodes includes a first electrode and a second electrode. The first electrode has a plurality of first tips, the second electrode has a plurality of second tips, and the first tips and the second tips are aligned with each other. The high-speed cameras are respectively positioned in different directions corresponding to the pair of electrodes.

The plasma generator of the disclosure includes at least one pair of electrodes and a power supply. The pair of electrodes includes a first electrode and a second electrode. The first electrode has a plurality of first tips, the second electrode has a plurality of second tips, and the first tips and the second tips are aligned with each other. The power supply outputs a voltage to the pair of electrodes.

Based on the above, by using the characteristic of exciting the gas to emit light through the plasma, the disclosure provides specific designs of the pair of electrodes to cause the electric power lines to be periodically densely distributed, and thus the technical means of non-uniform imaging plasma development can achieve the effect of image-capturing of a three-dimensional flow field, and the disclosure may be applied to flow field simulation verification analysis in a low-pressure chamber.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a flow field visualization device according to a first embodiment of the disclosure.

FIG. 2 is a schematic diagram of another pair of electrodes in the flow field visualization device of the first embodiment.

FIG. 3 is a schematic perspective diagram of a first electrode in the pair of electrodes in the flow field visualization device of the first embodiment.

FIG. 4 is a schematic perspective diagram of another first electrode in the pair of electrodes in the flow field visualization device of the first embodiment.

FIG. 5 is a schematic perspective diagram of still another first electrode in the pair of electrodes in the flow field visualization device of the first embodiment.

FIG. 6 is a diagram of flow field observation steps according to a second embodiment of the disclosure.

FIG. 7 is a schematic diagram of a plasma generator according to a third embodiment of the disclosure.

### DESCRIPTION OF THE EMBODIMENTS

The exemplary embodiments of the disclosure will be more comprehensively described below with reference to the drawings, but the disclosure may be further implemented in many different forms and should not be construed as limited to the embodiments described herein. For clarity of illustration, the relative thickness and position of regions or structures may be reduced or enlarged. In addition, similar or identical reference numerals are used in the drawings to represent similar or identical components.

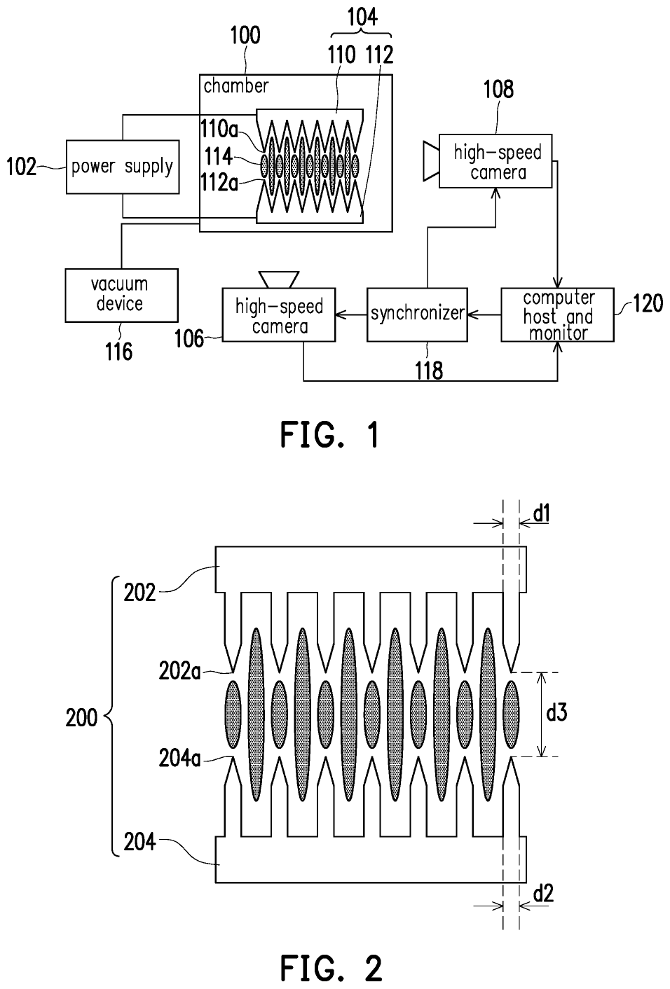

FIG. 1 is a block diagram of a flow field visualization device according to a first embodiment of the disclosure.

Referring to FIG. 1, the flow field visualization device of the first embodiment basically includes a chamber 100, a power supply 102, a pair of electrodes 104, and two high-speed cameras 106 and 108. The power supply 102 is used to output a voltage for plasma generation, and the power supply 102 is generally disposed outside the chamber 100 and electrically connected to the pair of electrodes 104 disposed in the chamber 100. The pair of electrodes 104 includes a first electrode 110 and a second electrode 112. The first electrode 110 has a plurality of first tips 110a, the second electrode 112 has a plurality of second tips 112a, and the first tips 110a and the second tips 112a are aligned with each other. Specifically, the shapes of the first electrode 110 and the second electrode 112, particularly the positions of the first tips 110a and the second tips 112a, are substantially mirror symmetric. Thus, the pair of electrodes 104 can generate a periodically densely distributed plasma 114 by exciting a gas (not shown) in the chamber 100 through the voltage from the power supply 102, and the gas is, for example, an inert gas. The high-speed cameras 106 and 108 are disposed outside the chamber 100, and the high-speed cameras 106 and 108 are positioned in different directions corresponding to the pair of electrodes 104.

Referring to FIG. 1 again, the flow field visualization device of the present embodiment may further include a vacuum device 116 for maintaining a vacuum state in the chamber 100. Therefore, the device of the disclosure can be applied to image capturing of a three-dimensional flow field in a chamber of low-pressure vacuum to address the issue that, in the related art, flow field simulation verification analysis using laser and particles cannot be performed at a low pressure. In addition, to control the exposure times of the high-speed cameras 106 and 108, a synchronizer 118 may be additionally disposed to sync the exposure times of the high-speed cameras 106 and 108 to facilitate image capturing of the three-dimensional flow field. If image analysis is to be performed, a computer host and monitor 120 may be further disposed to receive the images obtained by the high-speed cameras 106 and 108, control the frequency of the synchronizer 118, and analyze the captured images.

In FIG. 1, the first electrode 110 and the second electrode 112 are saw-shaped electrodes, and the so-called saw-shaped electrode is a structure that is tapered toward the first tips 110a and the second tips 112a. However, the disclosure is not limited thereto. The first electrode and the second electrode may also be pin-shaped electrodes, as shown in FIG. 2.

Referring to FIG. 2, for clarity, the figure only shows a pair of electrodes 200, which includes a first electrode 202 and a second electrode 204. The first electrode 202 has a plurality of first tips 202a, the second electrode 204 has a plurality of second tips 204a, and the first tips 202a and the second tips 204a are aligned with each other. In an embodiment, a diameter d1 of the first tip 202a and a diameter d2 of the second tip 204a are both about 2 mm to 3 mm, and a distance d3 between the first tip 202a and the second tip 204a is about 2 mm to 3 mm. However, the disclosure is not limited thereto. The diameters d1/d2 and the distance d3 may all be changed according to the requirements.

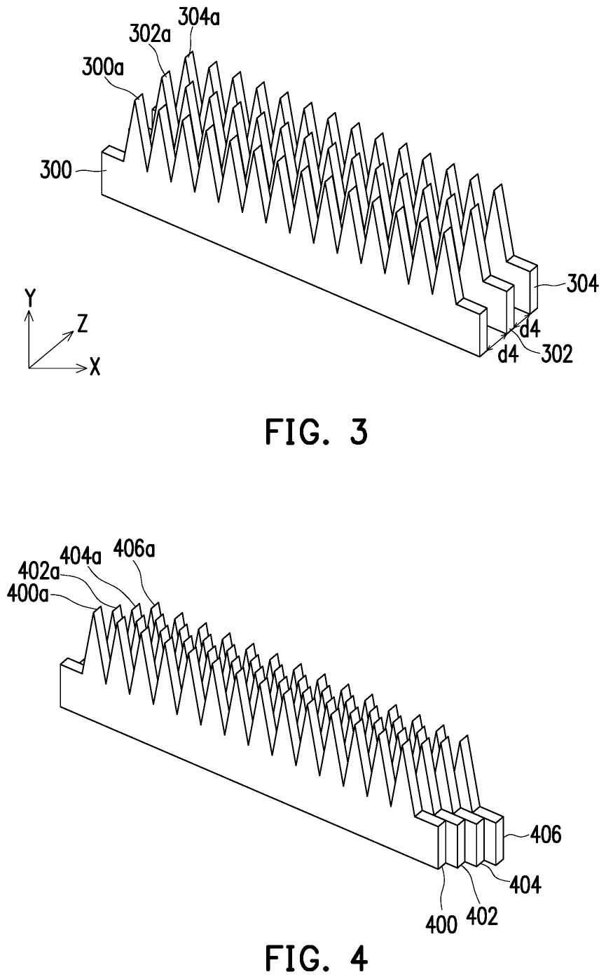

Further variation examples of the electrode will be described below, as shown in FIG. 3 to FIG. 5. In the figures, only one side of the pair of electrodes (e.g., the first electrode) is shown, and the other side of the pair of electrodes (e.g., the second electrode) is omitted since it is mirror symmetric.

In FIG. 3, if the number of the pair of electrodes in the flow field visualization device is plural (e.g., three), different first electrodes 300, 302, and 304 in the pairs of electrodes may have first tips 300a, 302a, and 304a aligned with each other and may be saw-shaped electrodes. For example, the first tips 300a, 302a, and 304a may be aligned along the Z-axis direction, which is a direction perpendicular to the long axis (X-axis) and the short axis (Y-axis) of the electrode. Moreover, the first electrodes 300, 302, and 304 may be spaced apart from each other by a distance d4, and the distance d4 is, for example, 2 mm to 3 mm. However, the disclosure is not limited thereto, and the distance d4 may be changed according to the requirements. Alternatively, the first electrodes 300, 302, and 304 may be in contact with each other without an interval. If there is an interval between the first electrodes 300, 302, and 304, the voltage of the power supply is supplied to each of the first electrodes 300, 302, and 304 respectively via lines. Since the second electrodes (not shown) are mirror symmetric with the first electrodes 300, 302, and 304, the number and shape of the second electrodes and the position of the second tips are all the same as those of the first electrodes 300, 302, and 304 and will not be repeatedly described herein.

In FIG. 4, the number of the pair of electrodes in the flow field visualization device is plural (e.g., four), and different first electrodes 400, 402, 404, and 406 in the pairs of electrodes may have first tips 400a, 402a, 404a, and 406a alternately arranged with each other and may be saw-shaped electrodes. The first electrodes 400, 402, 404, and 406 are in contact with each other, but the disclosure is not limited thereto. Alternatively, the first electrodes 400, 402, 404, and 406 may also be spaced apart from each other by a distance as shown in FIG. 3. Since the second electrodes (not shown) are mirror symmetric with the first electrodes 400, 402, 404, and 406, the number and shape of the second electrodes and the position of the second tips are all the same as those of the first electrodes 400, 402, 404, and 406 and will not be repeatedly described herein. The arrangement in FIG. 4 can generate a stronger plasma, of which the electric power lines are obviously periodically densely distributed and can thus present a subtler three-dimensional flow field image.

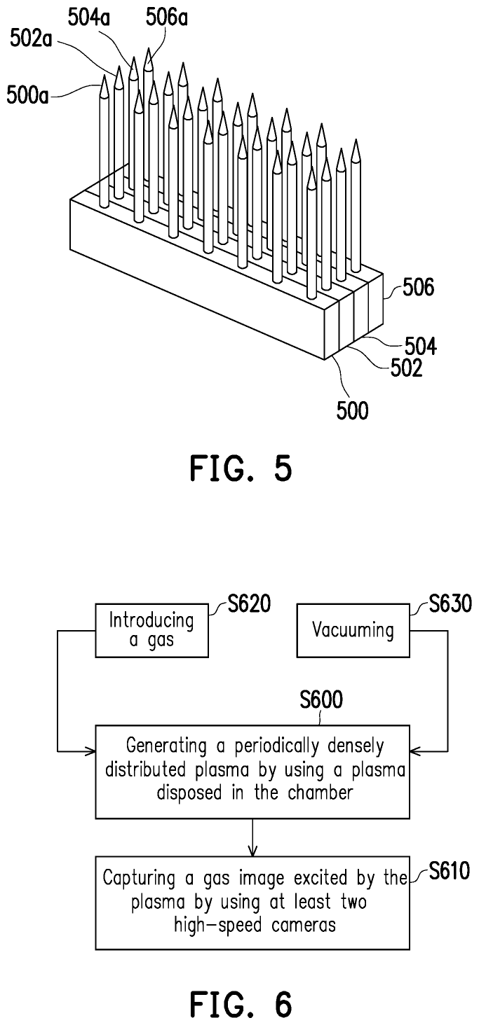

In FIG. 5, the number of the pair of electrodes in the flow field visualization device is plural (e.g., four), and different first electrodes 500, 502, 504, and 506 in the pairs of electrodes have first tips 500a, 502a, 504a, and 506a aligned with each other and are pin-shaped electrodes. The first electrodes 500, 502, 504, and 506 are in contact with each other, but the disclosure is not limited thereto. Alternatively, the first electrodes 500, 502, 504, and 506 may also be spaced apart from each other by a distance as shown in FIG. 3. Since the second electrodes (not shown) are mirror symmetric with the first electrodes 500, 502, 504, and 506, the number and shape of the second electrodes and the position of the second tips are all the same as those of the first electrodes 500, 502, 504, and 506 and will not be repeatedly described herein.

According to the first embodiment, after a high voltage power is supplied to the pair of electrodes in the various forms above, a plasma with periodically densely distributed electric power lines is generated, and the gas is excited by the plasma to emit light, which can thereby improve the image-capturing range of flow field visualization. Moreover, the issue that observation cannot be performed if the angle is not correct is not present in the plasma development of non-uniform imaging. Therefore, the arrangement in the embodiment is favorable for image acquisition. With the frequency of the high-speed cameras being further adjusted to perform global velocity field acquisition, the image capturing of the three-dimensional flow field can then be completed and the three-dimensional flow field can be analyzed.

FIG. 6 is a diagram of flow field observation steps according to a second embodiment of the disclosure.

Referring to FIG. 6, in step 5600, a periodically densely distributed plasma is generated by using a plasma generator disposed in the chamber, and the plasma generator includes the pair of electrodes as described in the first embodiment. The pair of electrodes includes a first electrode and a second electrode, the first electrode and the second electrode both have a plurality of tips, and the tips of the different electrodes are aligned with each other. Therefore, the periodically densely distributed plasma can be generated. Reference may be made to FIG. 1 to FIG. 5 for the detailed design of the pair of electrodes, which will not be repeatedly described herein.

Then, in step S610, a gas image excited by the plasma is captured by using at least two high-speed cameras. The high-speed cameras are respectively positioned in different directions corresponding to the pair of electrodes and thus can capture gas images in different directions. When the exposure times of the high-speed cameras are controlled to be the same, a displacement amount can be calculated through a particle tracking program based on the captured gas images, and an average displacement amount of different regions can be calculated by using the statistical method of correlation function to obtain a flow field velocity mapping in the chamber. Specifically, the gas may be excited by the plasma to emit light, and the frequency of the high-speed cameras may be adjusted to perform global velocity field acquisition. Next, the computer host is used to set a global area or volume, which is then divided into a plurality of equal areas (to avoid pairing errors resulting from an overly high velocity of gas particles) to track the movement of the gas particles in space and record it as the flow field velocity mapping. Therefore, in the spatial analysis process, the issue of regional overlapping, which may occur in conventional two-dimensional image processing, does not occur, and the study on exact solution of cross-correlation and perturbation approximation can be improved.

In addition, before step S600 is performed, a gas may be introduced into the chamber (step S620), and the introduced gas is, for example, an inert gas. Further, if the flow field to be tested is applied to a low-pressure vacuum state, the chamber is vacuumed (step S630) before step S600 is performed.

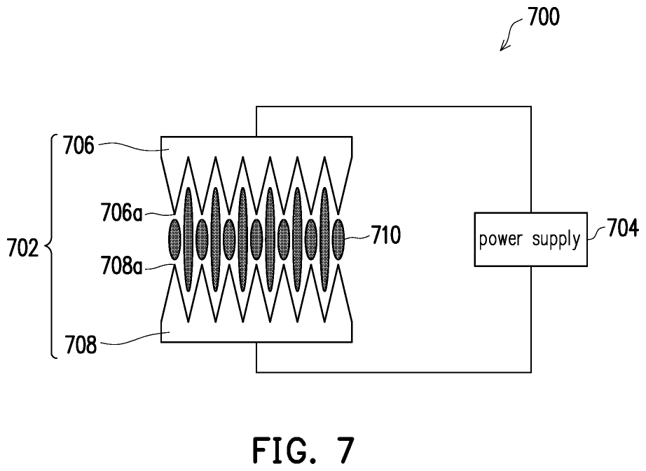

FIG. 7 is a schematic diagram of a plasma generator according to a third embodiment of the disclosure.

Referring to FIG. 7, a plasma generator 700 of the third embodiment includes at least one pair of electrodes 702 and a power supply 704, and the power supply 704 is used to output a voltage to the pair of electrodes 702. The pair of electrodes 702 includes a first electrode 706 and a second electrode 708, and the pair of electrodes 702 is the same as the pair of electrodes 104 or 200 of the first embodiment. Reference may be made to the electrode design of FIG. 3 to FIG. 5, which will not be repeatedly described herein. In the third embodiment, since first tips 706a of the first electrode 706 are aligned with second tips 708a of the second electrode 708, the voltage from the power supply 704 causes the pair of electrodes 702 to excite the gas (not shown) to generate a periodically densely distributed plasma. 710. The periodically densely distributed plasma 710 may be applied to related fields of non-uniform imaging plasma development.

In summary of the above, the flow field visualization device of the disclosure uses electrodes of specific structural designs and thus can generate a periodically densely distributed plasma. Moreover, the phenomenon that the plasma excites the gas to emit light (i.e., plasma development) is used to replace the conventional laser illumination, so the image can be directly acquired without considering the angle to achieve the effect of image capturing of the three-dimensional flow field. In addition, the embodiment may be applied to flow field simulation verification analysis in a low-pressure chamber, e.g., multiple reaction gas flow, air pressure, chemical behavior monitoring, etc. The plasma generator of the disclosure can generate a periodically densely distributed plasma, so it may be further applied to other fields, e.g., various chamber flow field changes, microchannel design, biomedicine, aerodynamics, meteorology, and other related applications.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A flow field visualization device comprising:
a chamber;
a power supply, outputting a voltage for plasma generation;
at least one pair of electrodes disposed in the chamber, wherein the pair of electrodes comprises a first electrode and a second electrode, the first electrode has a plurality of first tips, the second electrode has a plurality of second tips, the first tips and the second tips are aligned with each other, and the at least one pair of electrodes generates a periodically densely distributed plasma by exciting a gas in the chamber through the voltage from the power supply; and
at least two high-speed cameras disposed outside the chamber and positioned in different directions corresponding to the pair of electrodes.

2. The flow field visualization device according to claim 1, wherein the first electrode and the second electrode are saw-shaped electrodes or pin-shaped electrodes.

3. The flow field visualization device according to claim 1, wherein a number of the pair of electrodes is plural.

4. The flow field visualization device according to claim 3, wherein in the pairs of electrodes, the first tips of the different first electrodes are aligned with each other, and the second tips of the different second electrodes are aligned with each other.

5. The flow field visualization device according to claim 3, wherein in the pairs of electrodes, the first tips of the different first electrodes are alternately arranged with each other, and the second tips of the different second electrodes are alternately arranged with each other.

6. The flow field visualization device according to claim 3, wherein in the pairs of electrodes, the first electrodes are in contact with each other, and the second electrodes are in contact with each other.

7. The flow field visualization device according to claim 3, wherein in the pairs of electrodes, the first electrodes are spaced apart from each other by a distance, and the second electrodes are spaced apart from each other by the distance.

8. The flow field visualization device according to claim 1, wherein the gas comprises an inert gas.

9. A flow field observation method, comprising:
generating a periodically densely distributed plasma by using a plasma generator disposed in a chamber, wherein the plasma generator comprises at least one pair of electrodes, the pair of electrodes comprises a first electrode and a second electrode, the first electrode has a plurality of first tips, the second electrode has a plurality of second tips, and the first tips and the second tips are aligned with each other; and
capturing a gas image excited by the plasma by using at least two high-speed cameras respectively positioned in different directions corresponding to the pair of electrodes.

10. The flow field observation method according to claim 9, further comprising introducing the gas into the chamber, wherein the gas comprises an inert gas.

11. The flow field observation method according to claim 9, further comprising vacuuming the chamber before generating the plasma.

12. The flow field observation method according to claim 9, wherein exposure times of the high-speed cameras are the same.

13. The flow field observation method according to claim 9, wherein a displacement amount is calculated through a particle tracking program based on the captured gas image, and an average displacement amount of different regions is calculated by using a statistical method of correlation function to obtain a flow field velocity mapping in the chamber.

14. A plasma generator comprising:
at least one pair of electrodes comprising a first electrode and a second electrode, wherein the first electrode has a plurality of first tips, the second electrode has a plurality of second tips, and the first tips and the second tips are aligned with each other; and
a power supply, outputting a voltage to the at least one pair of electrodes.

15. The plasma generator according to claim 14, wherein the first electrode and the second electrode are saw-shaped electrodes or pin-shaped electrodes.

16. The plasma generator according to claim 14, wherein a number of the pair of electrodes is plural.

17. The plasma generator according to claim 16, wherein in the pairs of electrodes, the first tips of the different first electrodes are aligned with each other, and the second tips of the different second electrodes are aligned with each other.

18. The plasma generator according to claim 16, wherein in the pairs of electrodes, the first tips of the different first electrodes are alternately arranged with each other, and the second tips of the different second electrodes are alternately arranged with each other.

19. The plasma generator according to claim 16, wherein in the pairs of electrodes, the first electrodes are in contact with each other, and the second electrodes are in contact with each other.

20. The plasma generator according to claim 16, wherein in the pairs of electrodes, the first electrodes are spaced apart from each other by a distance, and the second electrodes are spaced apart from each other by the distance.
